(19) United States
(12) Patent Application Publication
(10) Pub. No.: US 2018/0129934 A1
(43) Pub. Date: May 10, 2018

(54) ENHANCED SIAMESE TRACKERS

(71) Applicant: QUALCOMM Incorporated, San Diego, CA (US)

(72) Inventors: Ran TAO, Amsterdam (NL); Efstratios GAVVES, Amsterdam (NL); Arnold Wilhelmus Maria SMEULDERS, Amsterdam (NL)

(21) Appl. No.: 15/621,741

(22) Filed: Jun. 13, 2017

Related U.S. Application Data
(60) Provisional application No. 62/418,704, filed on Nov. 7, 2016.

(51) Int. Cl. G06N 3/04; G06N 3/08

(52) U.S. Cl. CPC G06N 3/0454; G06N 3/084; G06K 9/00624; G06T 2207/20084; G06T 2207/20081; G06T 2207/10016

(57) ABSTRACT

In one configuration, a visual object tracking apparatus is provided that receives a position of an object in a first frame of a video, and determines a current position of the object in subsequent frames of the video using a Siamese neural network To facilitate determining the current position of the object, the apparatus may adjust a spatial resolution of an image, adjust a size of a probe region, and/or adjust a scale of a plurality of sampled images. In one configuration, a visual object tracking using a Siamese neural network is provided. The apparatus feeds outputs from a plurality of subnetworks of the Siamese neural network to a comparison layer. In addition, the apparatus compares, at the comparison layer, inputs from the plurality of subnetworks to generate a comparison result. Further, the apparatus combines comparison results based on weights to obtain a final comparison result.

### CROSS-REFERENCE TO RELATED APPLICATION(S)

This application claims the benefit of U.S. Provisional Application Ser. No. 62/418,704, entitled “ENHANCED SIAMESE TRACKERS” and filed on Nov. 7, 2016, which is expressly incorporated by reference herein in its entirety.

### BACKGROUND

### Field

The present disclosure relates generally to machine learning, and more particularly, to Siamese trackers.

### Background

An artificial neural network, which may include an interconnected group of artificial neurons, may be a computational device or may represent a method to be performed by a computational device. Artificial neural networks may have corresponding structure and/or function in biological neural networks. However, artificial neural networks may provide innovative and useful computational techniques for certain applications in which traditional computational techniques may be cumbersome, impractical, or inadequate. Because artificial neural networks may infer a function from observations, such networks may be particularly useful in applications where the complexity of the task or data makes the design of the function by conventional techniques burdensome.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

Visual object tracking is the task of estimating the location of a target object over a video given an image of the object at the start. Tracking is a fundamental research problem of computer vision. Tracking has numerous follow-on applications in surveillance, robotics and human computer interaction, or all applications where the object location is important over time.

Algorithms for visual object tracking may fall into two families of approaches. One family includes the visual object trackers that discriminate the target from the background. The discrimination may be learned on the fly from the previous frame/frames. The prevalent computational method for the family of discriminative trackers may be based on the discriminative correlation filter (DCF). Discriminative trackers may update their functions in each frame, relying on the target appearance from the target location predicted in the previous frame. The target appearance might change due to a variety of reasons that relate to environmental and not object-related factors, such as occlusion or specularities. As such, the updating of a discriminative tracker function may learn accidental artifacts that will derail the tracker soon after. Thus, discriminative trackers may not function well if false updates degrade the internal model of the trackers.

An alternative family of visual object trackers is generative trackers, which search in the current frame for the candidate most similarity to the start image of the target. The oldest of the generative trackers is the NCC tracker, where the similarity function measures the similarity of the intensity values of two image patches. In generative trackers, a complex but generic similarity function may be learned off-line by specialized deep Siamese networks. The deep Siamese networks may be trained to properly measure similarity for any object submitted for tracking. A generative tracker using a Siamese network may be referred to as a Siamese tracker. The online tracking strategy of a Siamese tracker may be simple—just finding a local maximum of the run-time-fixed similarity function. Siamese trackers may show comparable results to DCF trackers on tracking benchmarks. The deep Siamese neural networks in these trackers may be able to learn all typical appearance variations of an object. Hence, the Siamese trackers may no longer require online updating during the tracking, which may reduce the likelihood of the internal model of the trackers getting corrupted.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for visual object tracking are provided. The apparatus may receive a position of an object in a first/starting frame of a video. The apparatus may determine a current position of the object in subsequent frames of the video using a Siamese neural network. To determine the current position of the object in the current frame under processing, the apparatus may adjust the spatial resolution of a first image from the first/starting frame of the video and a second image sampled from the current frame under processing. The first image and the second image may be inputs to the Siamese neural network. To determine the current position of the object in the current frame under processing, the apparatus may adjust the size of the probe region on the current frame under processing based on a metric of movement of the object from one frame to another. To determine the current position of the object in the current frame under processing, the apparatus may adjust the scale of a plurality of images sampled from the current frame under processing. The plurality of images may be inputs to the Siamese neural network.

In another aspect of the disclosure, a method, a computer-readable medium, and an apparatus for visual object tracking using a Siamese neural network are provided. The apparatus may feed outputs from a plurality of layers of a first subnetwork of the Siamese neural network and a second subnetwork of the Siamese neural network to a comparison layer. The apparatus may compare, at the comparison layer for each layer of the plurality of layers, a first input from the layer in the first subnetwork with a second input from the layer in the second subnetwork to obtain a comparison result for the layer. The apparatus may combine comparison results for the plurality of layers based on weights dynamically generated for the plurality of layers to obtain a final comparison result.

In yet another aspect of the disclosure, a method, a computer-readable medium, and an apparatus for visual object tracking are provided. The apparatus may divide each of a first image and a second image into the same number of regions. Each region of the first image may have the same shape and size as a corresponding region of the second image. The apparatus may compare each region of the first image with the corresponding region of the second image to obtain a similarity score for the region. The apparatus may determine, for each region of the second image, whether the region is occluded based on the similarity score for the region and similarity scores for other regions. The apparatus may determine a similarity between the first image and the second image based on similarity scores for regions that are un-occluded.

In yet another aspect of the disclosure, a method, a computer-readable medium, and an apparatus for determining occluded portions in a frame through a Siamese neural network is provided. The apparatus compares a first plurality of subregions of a subregion of a probe region of a current frame with a second plurality of subregions of a query region of an initial frame. In addition, the apparatus determines a similarity score for each of the first plurality of subregions based on the comparison. Further, the apparatus determines that a first set of subregions of the first plurality of subregions is occluded when the similarity score for each subregion of the first set of subregions is less than a first threshold and when the similarity score for each subregion of a second set of subregions is greater than a second threshold. The second threshold is greater than the first threshold.

To the accomplishment of the foregoing and related ends, the one or more aspects comprise the features hereinafter fully described and particularly pointed out in the claims. The following description and the annexed drawings set forth in detail certain illustrative features of the one or more aspects. The features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an exemplary artificial neural network with multiple levels of neurons.

FIG. 2 illustrates an exemplary diagram of a processing unit (e.g., a neuron or neuron circuit) of a computational network (e.g., a neural network).

FIG. 3 is a diagram illustrating an example of visual object tracking in a video.

FIG. 4 is a diagram illustrating an example of the effect of spatial resolution on the performance of a Siamese tracker to track an object.

FIG. 5 is a diagram illustrating an example of adjusting the probe region for Siamese tracker.

FIG. 6 is a diagram illustrating an example of searching for the target in the probe region with different scales for a Siamese tracker.

FIG. 7 is a flowchart of a method of visual object tracking.

FIG. 8 is a diagram illustrating an example of visual object tracking using a Siamese tracker with weighted multi-layer fusion.

FIG. 9 is a flowchart of a method of visual object tracking.

FIG. 10 is a diagram that illustrates an example of occlusion prediction for visual object tracking using a Siamese tracker.

FIG. 11 is a flowchart of a method of visual object tracking.

FIG. 12 is a conceptual data flow diagram illustrating the data flow between different means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computing systems for artificial neural networks will now be presented with reference to various apparatus and methods. The apparatus and methods will be described in the following detailed description and illustrated in the accompanying drawings by various blocks, components, circuits, processes, algorithms, etc. (collectively referred to as “elements”). The elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

An artificial neural network may be defined by three types of parameters: 1) the interconnection pattern between the different layers of neurons; 2) the learning process for updating the weights of the interconnections; and 3) the activation function that converts a neuron's weighted input to the neuron's output activation. Neural networks may be designed with a variety of connectivity patterns. In feed-forward networks, information is passed from lower layers to higher layers, with each neuron in a given layer communicating with neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

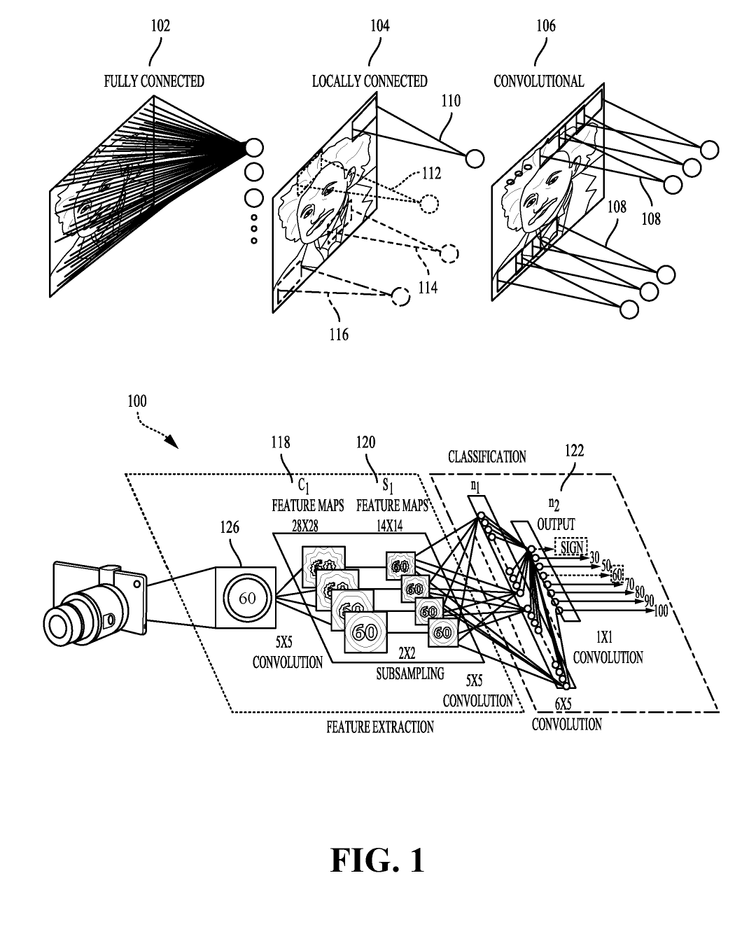

FIG. 1 is a diagram illustrating a neural network in accordance with aspects of the present disclosure. As shown in FIG. 1, the connections between layers of a neural network may be fully connected 102 or locally connected 104. In a fully connected network 102, a neuron in a first layer may communicate the neuron's output to every neuron in a second layer, so that each neuron in the second layer receives an input from every neuron in the first layer. Alternatively, in a locally connected network 104, a neuron in a first layer may be connected to a limited number of neurons in the second layer. A convolutional network 106 may be locally connected, and is further configured such that the connection strengths associated with the inputs for each neuron in the second layer are shared (e.g., connection strength 108). More generally, a locally connected layer of a network may be configured so that each neuron in a layer will have the same or a similar connectivity pattern, but with connections strengths that may have different values (e.g., 110, 112, 114, and 116). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a neural network 100 designed to recognize visual features from a car-mounted camera may develop high layer neurons with different properties depending on their association with the lower portion of the image versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be trained with supervised learning. During training, a DCN may be presented with an image 126, such as a cropped image of a speed limit sign, and a “forward pass” may then be computed to produce an output 122. The output 122 may be a vector of values corresponding to features of the image such as “sign,” “60,” and “100.” The network designer may want the DCN to output a high score for some of the neurons in the output feature vector, for example the ones corresponding to “sign” and “60” as shown in the output 122 for a neural network 100 that has been trained. Before training, the output produced by the DCN is likely to be incorrect, and so an error may be calculated between the actual output of the DCN and the target output desired from the DCN. The weights of the DCN may then be adjusted so that the output scores of the DCN are more closely aligned with the target output.

To adjust the weights, a learning algorithm may compute a gradient vector for the weights. The gradient may indicate an amount that an error would increase or decrease if the weight were adjusted slightly. At the top layer, the gradient may correspond directly to the value of a weight associated with an interconnection connecting an activated neuron in the penultimate layer and a neuron in the output layer. In lower layers, the gradient may depend on the value of the weights and on the computed error gradients of the higher layers. The weights may then be adjusted so as to reduce the error. Such a manner of adjusting the weights may be referred to as “back propagation” as the manner of adjusting weights involves a “backward pass” through the neural network.

In practice, the error gradient for the weights may be calculated over a small number of examples, so that the calculated gradient approximates the true error gradient. Such an approximation method may be referred to as a stochastic gradient descent. The stochastic gradient descent may be repeated until the achievable error rate of the entire system has stopped decreasing or until the error rate has reached a target level.

After learning, the DCN may be presented with new images 126 and a forward pass through the network may yield an output 122 that may be considered an inference or a prediction of the DCN.

Deep convolutional networks (DCNs) are networks of convolutional networks, configured with additional pooling and normalization layers. DCNs may achieve state-of-the-art performance on many tasks. DCNs may be trained using supervised learning in which both the input and output targets are known for many exemplars. The known input targets and output targets may be used to modify the weights of the network by use of gradient descent methods.

DCNs may be feed-forward networks. In addition, as described above, the connections from a neuron in a first layer of a DCN to a group of neurons in the next higher layer of the DCN are shared across the neurons in the first layer. The feed-forward and shared connections of DCNs may be exploited for fast processing. The computational burden of a DCN may be much less, for example, than that of a similarly sized neural network that includes recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered a three-dimensional network, with two spatial dimensions along the axes of the image and a third dimension capturing color information. The outputs of the convolutional connections may be considered to form a feature map in the subsequent layer 118 and 120, with each element of the feature map (e.g., 120) receiving input from a range of neurons in the previous layer (e.g., 118) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

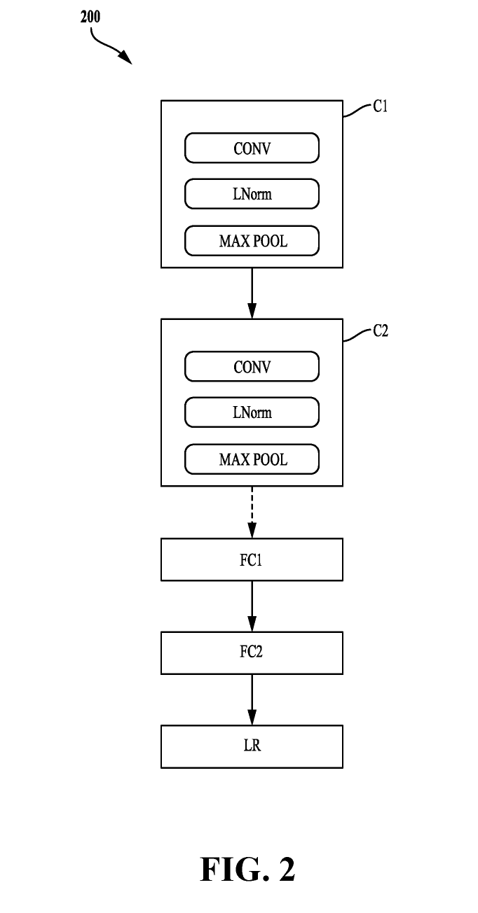

FIG. 2 is a block diagram illustrating an exemplary deep convolutional network 200. The deep convolutional network 200 may include multiple different types of layers based on connectivity and weight sharing. As shown in FIG. 2, the exemplary deep convolutional network 200 includes multiple convolution blocks (e.g., C1 and C2). Each of the convolution blocks may be configured with a convolution layer (CONV), a normalization layer (LNorm), and a pooling layer (MAX POOL). Each convolution layer may include one or more convolutional filters, which may be applied to the input data to generate a feature map. Although two convolution blocks are shown, the present disclosure is not so limited, and instead, any number of convolutional blocks may be included in the deep convolutional network 200 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU or GPU of a system on a chip (SOC), optionally based on an Advanced RISC Machine (ARM) instruction set, to achieve high performance and low power consumption. In alternative embodiments, the parallel filter banks may be loaded on the DSP or an image signal processor (ISP) of an SOC. In addition, the DCN may access other processing blocks that may be present on the SOC, such as processing blocks dedicated to sensors and navigation.

The deep convolutional network 200 may also include one or more fully connected layers (e.g., FC1 and FC2). The deep convolutional network 200 may further include a logistic regression (LR) layer. Between each layer of the deep convolutional network 200 are weights (not shown) that may be updated. The output of each layer may serve as an input of a succeeding layer in the deep convolutional network 200 to learn hierarchical feature representations from input data (e.g., images, audio, video, sensor data and/or other input data) supplied at the first convolution block C1.

The neural network 100 or the deep convolutional network 200 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software component executed by a processor, or any combination thereof. The neural network 100 or the deep convolutional network 200 may be utilized in a large range of applications, such as image and pattern recognition, machine learning, motor control, and the like. Each neuron in the neural network 100 or the deep convolutional network 200 may be implemented as a neuron circuit.

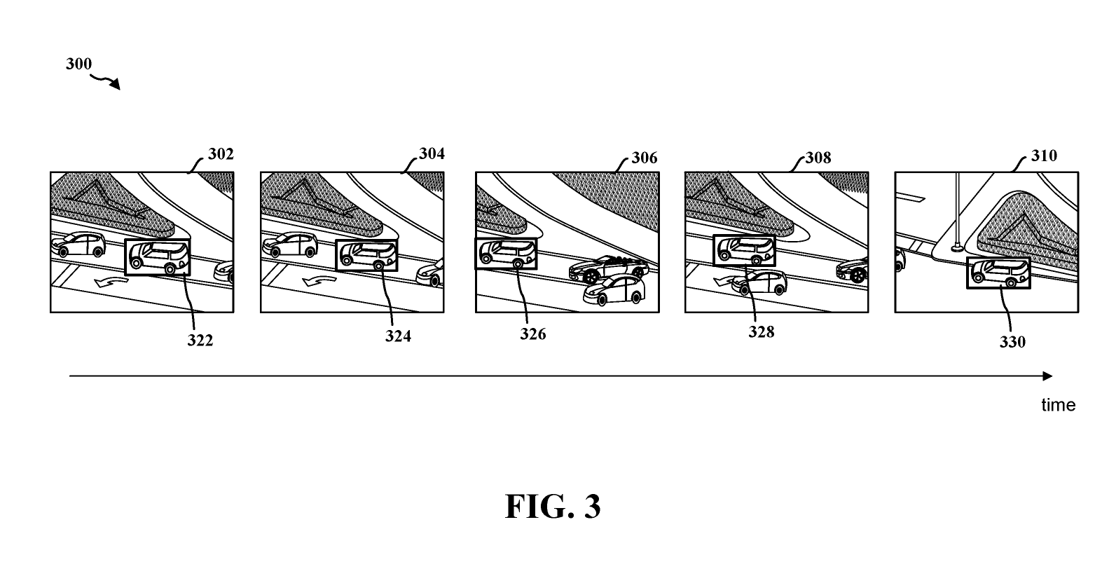

In certain aspects, the neural network 100 or the deep convolutional network 200 may be configured to track visual objects, as will be described below with reference to FIGS. 3-13.

A Siamese neural network is a class of neural networks that contain two or more identical subnetworks. The two or more subnetworks are identical because the subnetworks may have the same configuration with the same parameters and weights. Parameter updating may be mirrored across all subnetworks. Siamese neural networks may be applied to tasks that involve finding similarity or a relationship between two comparable things. For example, a Siamese neural network may be used in visual object tracking. The input to a first subnetwork of the Siamese neural network may be an image of an object in the first/starting frame of a video, and the input to a second subnetwork of the Siamese neural network may be an image sampled from a subsequent frame of the video. The output of the Siamese neural network may be how similar the two inputs are. If the two inputs of the Siamese neural network are similar to a certain degree, the location of the target object in the subsequent frame may be identified.

FIG. 3 is a diagram 300 illustrating an example of visual object tracking in a video. In this example, a vehicle may be first identified at location 322 in the first/starting frame 302 of the video. In the subsequent frames of the video, the location of the vehicle may be tracked based on the initial image of the vehicle identified at location 322. For example, the estimated vehicle location in subsequent frames 304, 306, 308, and 310 may be 324, 326, 328, and 330, respectively. In one configuration, the visual object tracking may be performed by a Siamese tracker.

Spatial resolution is the size of image region input to the neural network. If the image region is up-sampled or down-sampled to increase or to reduce the spatial resolution, the size of the target object within the image region will increase or decrease accordingly.

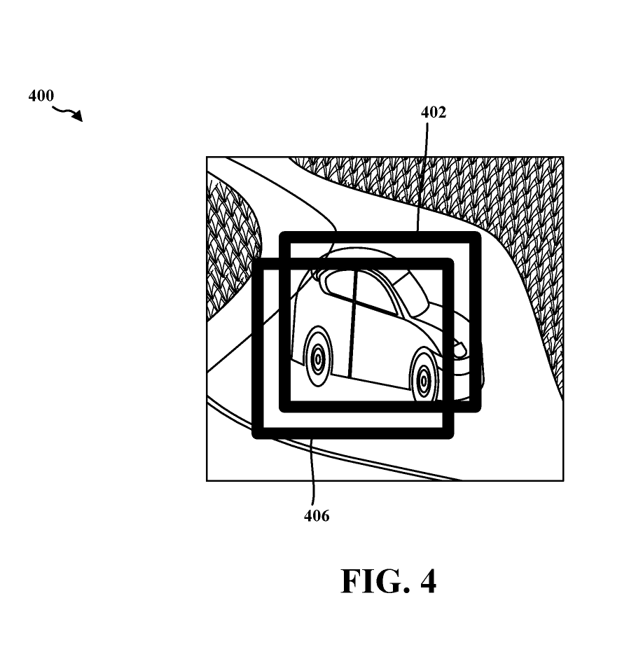

FIG. 4 is a diagram 400 illustrating an example of the effect of spatial resolution on the performance of a Siamese tracker to track an object. It may be desirable for the Siamese tracker to be able to tell that the candidate 402 is better than the candidate 406. However, The Siamese neural network may cause reduction in spatial resolution due to max pooling layers and the stride in the convolution layers. A 2×2 max pooling layer of the Siamese neural network may result in a 2-fold reduction in spatial resolution. For example, if the resolution of candidate 402 or 406 is originally 20×20 when inputted into the Siamese neural network, the resolution of candidate 402 or 406 may become 10×10 after being propagated through the 2×2 max pooling layer. For a network with 3 max pooling layers, there may be an 8-fold reduction in resolution.

As a consequence of the spatial reduction, the tracker built upon the network may be insensitive to a certain amount of shift in the bounding box. Assume the Siamese neural network has an 8-fold reduction, then the tracker may be insensitive to a 7-pixel shift in the bounding box. A 7-pixel shift may cause significant localization error when the size of the target object is small (e.g., in terms of number of pixels). For example, in an extreme case, say the target is 7×7 pixels in size, then a 7-pixel shift means the bounding box may be completely off the target. After the spatial reduction, the candidates 402 and 406 may sit on top of each other, and thus become identical. Hence, the input resolution of the image patch needs to be large enough and accordingly the size of the target object will be large enough so that the insensitivity to a certain amount of shift in the bounding box will not cause a noticeable localization error.

If the target is big, say 700×700, then a 7-pixel shift has almost no effect in localization accuracy. On the other hand, the input resolution cannot be arbitrarily large for at least two reasons. One reason is computation demand. The other reason is that too much up-sampling of the original image may introduce undesired artifacts. In one configuration, the size of the image region may be set such that the target is big enough such that the shift to which the tracker is insensitive will not result in a large localization error. In one configuration, the Siamese tracker may up-sample or down-sample the image region to increase or to decrease the input image resolution, thus optimizing the performance of visual object tracking. In one configuration, the Siamese tracker may adjust spatial resolution based on the amount of spatial reduction that the Siamese neural network may cause and/or the size of the target object.

A probe region is a subregion of the whole frame within which the target object may be located. If the probe region is too small, the target object may be located outside of the probe region. Thus, the Siamese tracker may miss the target object. If the probe region is too large, heavy computation may be needed for carrying out the visual object tracking. In addition, with a large probe region, there may be more potential confusion as more background is included in the probe region.

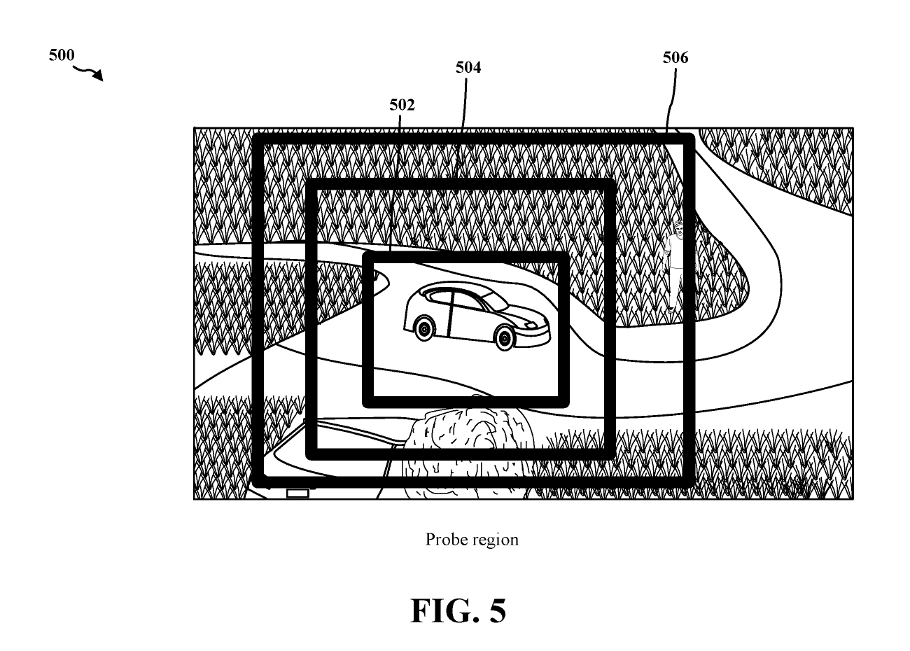

FIG. 5 is a diagram 500 illustrating an example of adjusting the probe region for a Siamese tracker. In the example, three probe regions 502, 504, and 506, each with a different size, are illustrated. The probe region may be centered around the predicted location in the previous frame, which means the size of probe region may be dependent on how much the object can move from one frame to the next frame. In one configuration, the size of the probe region may be adjusted based on a measure of movement of the object (e.g., how much the object can move from one frame to the next frame).

Once the probe region is determined, the Siamese tracker may slide in the probe region to find the window that has a high similarity to the initial bonding box containing the target object in the first/starting frame. The target object may change scale over time. In order to account for the target object changing scale over time, the Siamese tracker may need to sample the windows with different window sizes.

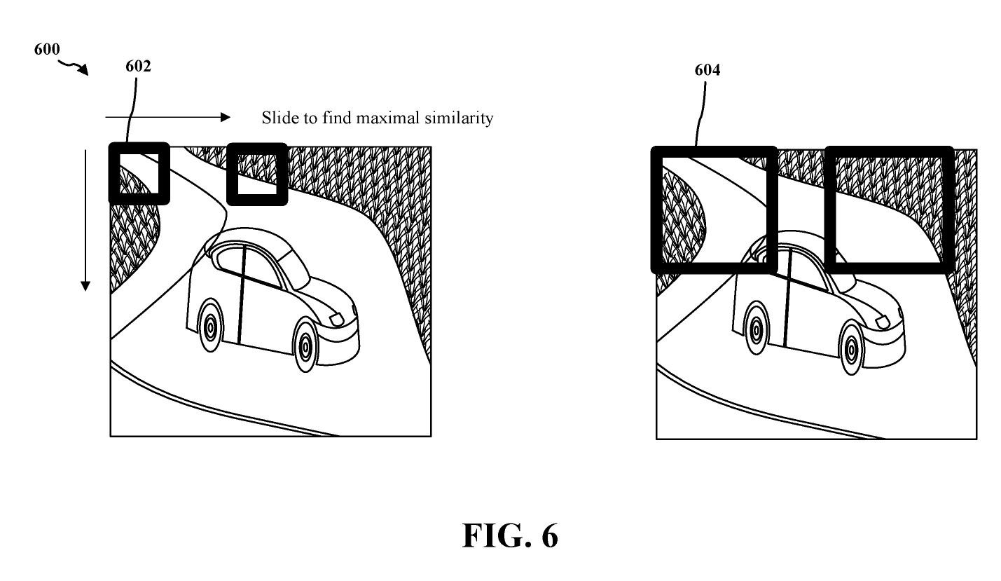

FIG. 6 is a diagram 600 illustrating an example of searching for the target in the probe region with different scales for a Siamese tracker. In one configuration, the scale may include the different window sizes for sampling. As illustrated, the Siamese tracker may slide a smaller window 602 vertically and horizontally to search for the target object. In addition, the Siamese tracker may slide a bigger window 604 vertically and horizontally to search for the target object. In one configuration, the Siamese tracker may adjust the number of different sampling (window) sizes, and the sizes of the windows. In one configuration, the Siamese tracker may sample multiple scales conditioned on the scale in the previous frame instead of conditioned on the first/starting frame. When it is conditioned on the first/starting frame, a fixed set of scales may be used throughout the whole video. Alternatively, by conditioning on the previous scale, the scales can be sampled continuously over time and hence finer.

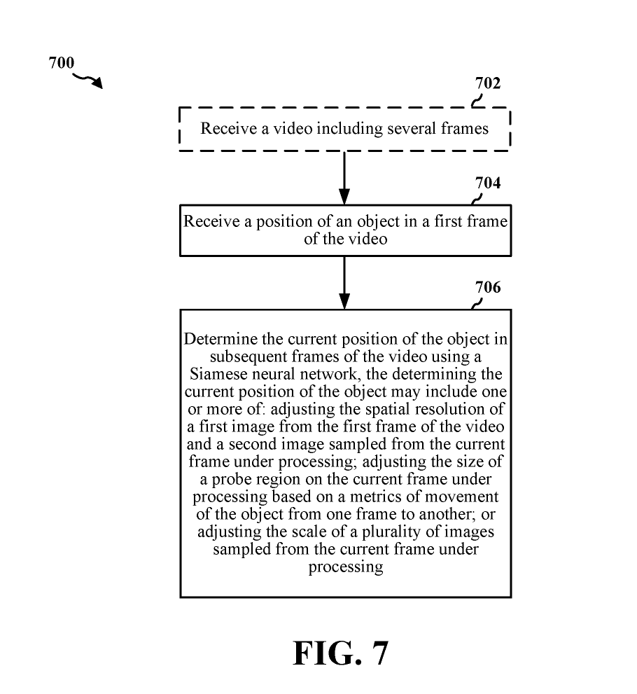

FIG. 7 is a flowchart 700 of a method of visual object tracking. The method may be performed by a computing device (e.g., the apparatus 1202/1202′) that is configured as a Siamese tracker. At 702, the device may optionally receive a video that includes several frames. At 704, the device may receive the position of an object in a first/starting frame of the video. In one configuration, the position may be defined by a rectangle.

At 706, the device may determine the current position of the object in subsequent frames of the video using a Siamese neural network. The determining of the current position of the object may include one or more of: 1) adjusting the spatial resolution of a first image from the first/starting frame of the video and a second image sampled from the current frame under processing, the first image and the second image being inputs to the Siamese neural network; 2) adjusting the size of the probe region on the current frame under processing based on a metric of movement of the object from one frame to another; or 3) adjusting the scale of a plurality of images sampled from the current frame under processing, the plurality of images being inputs to the Siamese neural network.

In one configuration, the spatial resolution of the first image and the second image may be adjusted based on the size of the object and/or the amount of spatial reduction caused by the Siamese neural network. In one configuration, to adjust the spatial resolution of the first image and the second image, the device may up-sample or down-sample a first image region on the first/starting frame and a second image region on the current frame. In one configuration, the scale of the plurality of images may include the sizes of the images. In one configuration, the scale of the plurality of images may be adjusted based on an estimated scale in the frame immediately before the current frame.

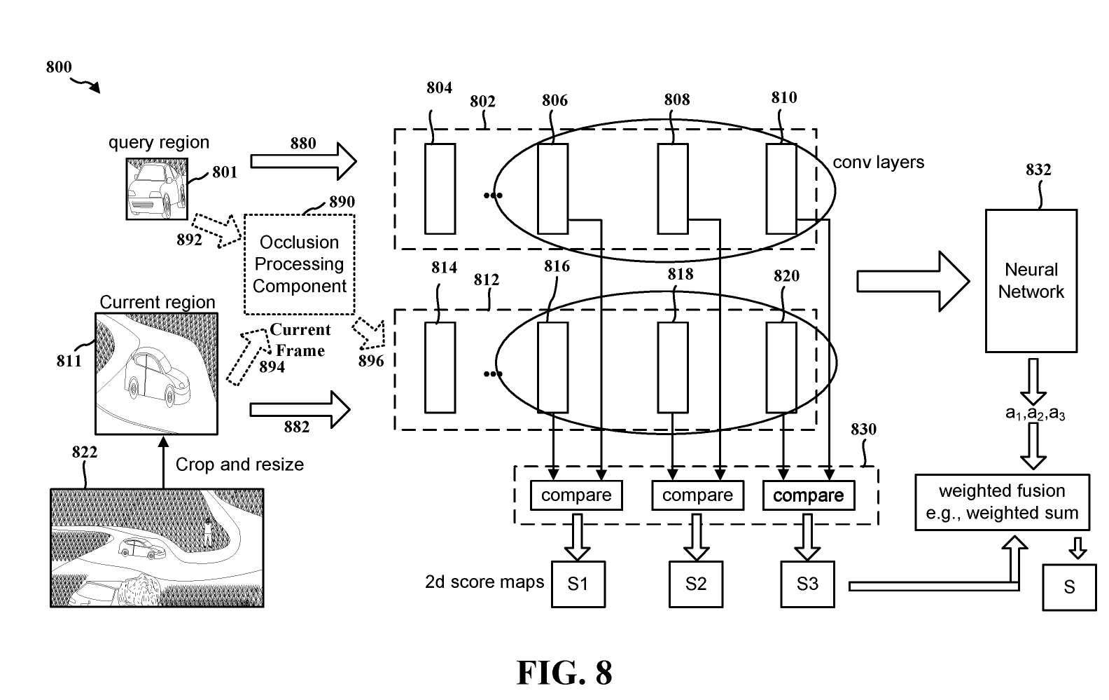

FIG. 8 is a diagram illustrating an example of visual object tracking using a Siamese tracker 800 with weighted multi-layer fusion. In the example, the Siamese tracker 800 may include two identical subnetworks 802 and 812. The subnetworks 802 and 812 may have the same configuration with the same parameters and weights. Each of the subnetworks may have several layers of neurons (e.g., convolution layers). For example, the subnetwork 802 may have layers 804, 806, 808, and 810, and the subnetwork 812 may have layers 814, 816, 818, and 820. Layer 804 of the subnetwork 802 may correspond to and be identical to layer 814 of the subnetwork 812. Layer 806 of the subnetwork 802 may correspond to and be identical to layer 816 of the subnetwork 812. Layer 808 of the subnetwork 802 may correspond to and be identical to layer 818 of the subnetwork 812. Layer 810 of the subnetwork 802 may correspond to and be identical to layer 820 of the subnetwork 812.

The subnetwork 802 may receive 880 an input image 801 that represents a query region, which may include the target object. In one configuration, the input image 801 may be extracted from the first/starting frame of a video. The subnetwork 812 may receive 882 an input image 811 that represents the current region under processing. In one configuration, the input image 811 may be sampled (e.g., cropped and resized as discussed supra with respect to FIGS. 4-7) from the current frame 822 under processing.

Different layers of the subnetworks 802 and 812 may represent different levels of detail. For example, layers 806 and 816 may represent low-level texture, and layers 808 and 818 may represent high-level object categorical evidence. In one configuration, several layers (e.g., penultimate layers 806, 808, and 810) of the subnetworks 802 and 812 may be fed into the comparison layer 830. The output of layer 806 may be compared to the output of layer 816 to obtain a comparison result S₁. The output of layer 808 may be compared to the output of layer 818 to obtain a comparison result S₂. The output of layer 810 may be compared to the output of layer 820 to obtain a comparison result S₃.

In one configuration, the Siamese tracker 800 may obtain a sum of the comparison results of different layers (e.g., S₁+S₂+S₃) to obtain the final comparison result between the input images 801 and 811. However, simply summing up comparison results of different layers may give equal weight to different levels of detail, thus ignoring the possibility that different levels of detail may make different contributions in finding the target object under different circumstances. Sometimes, it may be beneficial to rely on low-level texture to find the target object. Sometimes, it may be beneficial to rely on high-level object categorical evidence to find the target object. However, at other times, relying on high-level object categorical evidence may lead to confusion with other similar objects.

In one configuration, the comparison results of different layers (e.g., S₁, S₂, and S₃) may be weighted according to the tracking situation. The Siamese tracker 800 may include a neural network 832. In one configuration, the neural network 832 may be a multi-layer perceptron. The neural network 832 may take the target response maps (e.g., S₁, S₂, S₃) from various layers (e.g., the layers 806, 808, 810, 816, 818, 820) of the subnetwork 802 and 812 as input, and output the weights (e.g., a₁, a₂, a₃) for the layers to perform weighted fusion of the target response maps. Each value on the target response map may be the similarity between the corresponding local region (within 811) and the query region from the first/starting frame. In one configuration, the weights generated by the neural network 832 (e.g., a₁, a₂, a₃) may be combined with the comparison results of different layers (e.g., S₁, S₂, S₃) to compute a weighted fusion (e.g., weighted sum or weighted average) to obtain the final comparison result S.

In one configuration, the weights may be determined automatically based on the tracking situation. In one configuration, the weights may be determined dynamically, e.g., depending on the current frame. The weights may represent the importance of each layer to deriving the final comparison.

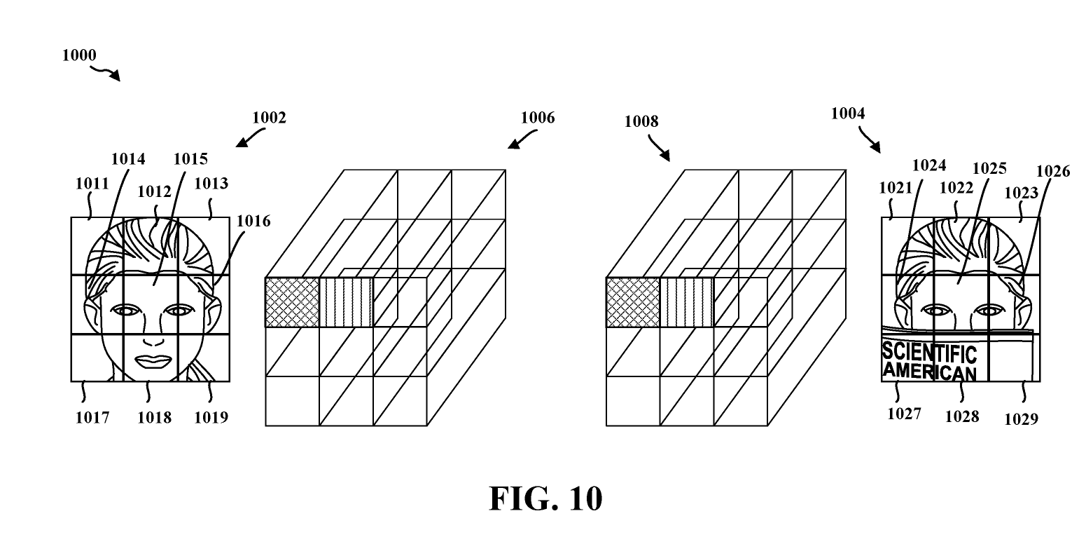

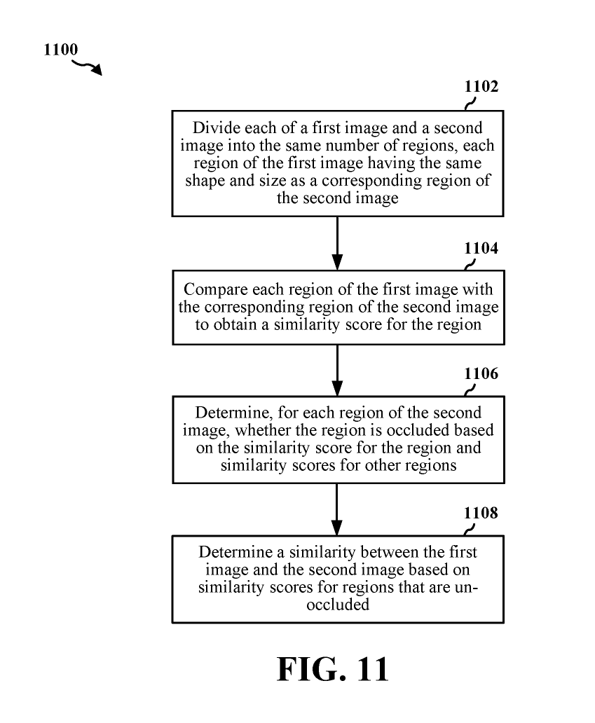

In one configuration, visual object tracking using a Siamese neural network is not integrated with a occlusion processing component 890. In another configuration, visual object tracking using a Siamese neural network is integrated with a occlusion processing component 890. In such a configuration, the input image 811 of the current frame may be provided 894 to an occlusion processing component 890. The occlusion processing component 890 may obtain a candidate window/box (subregion of the input image 811) that is determined to include just the target object. The occlusion processing component 890 further receives 892 a corresponding image from the input image 801 of the query region of an initial (first/starting) frame. The occlusion processing component 890 may split the images (input image 801 and candidate window/box/subregion of input image 811) into regions (see infra for further discussion in relation to FIGS. 10, 11), compare the regions of the current and initial frames to determine which regions and/or pixels are occluded and/or which ones are not, and provide 896 only the non-occluded/un-occluded regions (portions) to the subnetwork 812.

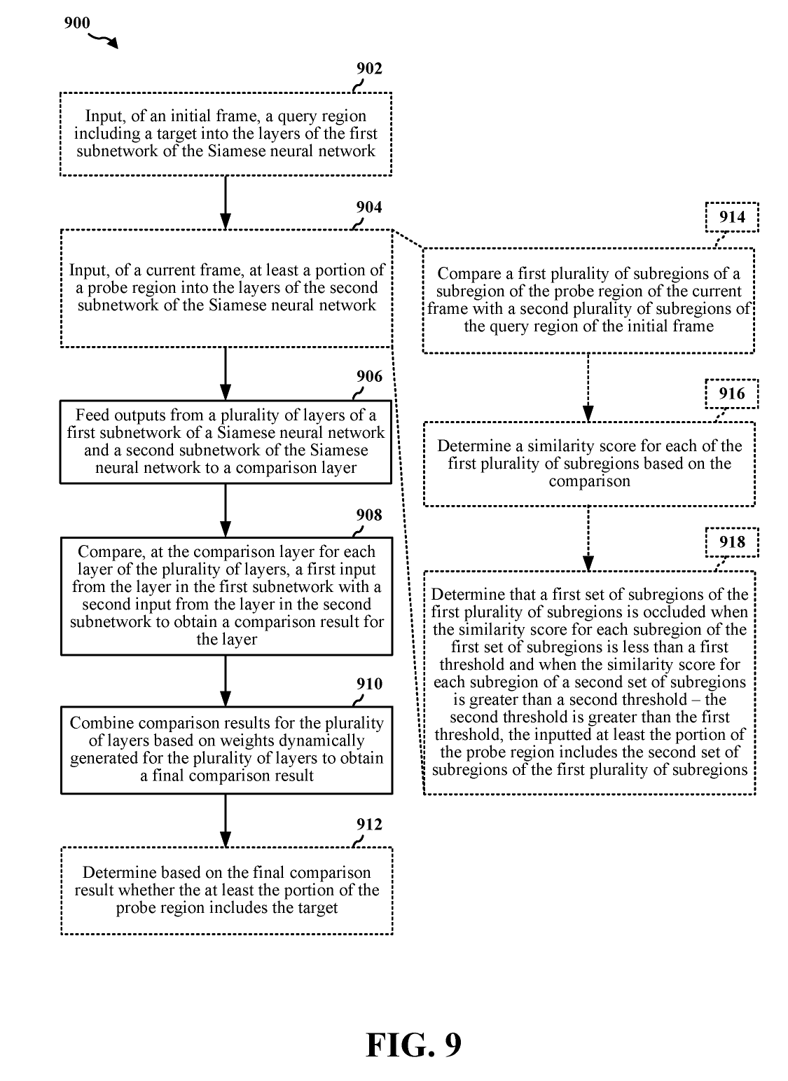

FIG. 9 is a flowchart 900 of a method of visual object tracking. The method may be performed by a computing device (e.g., the apparatus 1202/1202′) that is configured as a Siamese tracker. Optional blocks are illustrated with dotted lines. At 906, the device may feed outputs from a plurality of layers of a first subnetwork of a Siamese neural network and a second subnetwork of the Siamese neural network to a comparison layer. In one configuration, the first subnetwork and the second subnetwork may be identical. In one configuration, the plurality of layers may be penultimate layers of the first subnetwork and the second subnetwork.

At 908, the device may compare, at the comparison layer for each layer of the plurality of layers, a first input from the layer in the first subnetwork with a second input from the layer in the second subnetwork to obtain a comparison result for the layer.

At 910, the device may combine comparison results for the plurality of layers based on weights dynamically generated for the plurality of layers to obtain a final comparison result. In one configuration, the weights may be generated by a neural network that is trained concurrently with the Siamese neural network. In one configuration, the final comparison result is a weighted fusion (e.g., weighted sum or weighted average) of the comparison results for the plurality of layers.

Before 906, at 902, the device may input, of an initial frame, a query region including a target into the layers of the first subnetwork of the Siamese neural network. In addition, at 904, the device may input, of a current frame, at least a portion of a probe region into the layers of the second subnetwork of the Siamese neural network. Subsequent to 910, at 912, the device may determine based on the final comparison result whether the at least the portion of the probe region includes the target.

Traditional Siamese trackers may not consider mechanisms for dealing with occlusions. The similarity function of traditional Siamese trackers may naively compare the whole query image with a candidate target image even if one or both of the images are significantly occluded. Hence, the occluding parts may contribute equally to the similarity function. In one configuration, the Siamese tracker may be modified to take occlusions into consideration when predicting the target location.

Specifically, at 904, to determine the portion of the probe region to input into the second subnetwork, the device may perform one or more of 914, 916, 918. At 914, the device may compare a first plurality of subregions of a subregion of the probe region of the current frame with a second plurality of subregions of the query region of the initial frame. In addition, at 916, the device may determine a similarity score for each of the first plurality of subregions based on the comparison. Further, at 918, the device may determine that a first set of subregions of the first plurality of subregions is occluded when the similarity score for each subregion of the first set of subregions is less than a first threshold and when the similarity score for each subregion of a second set of subregions is greater than a second threshold, where the second threshold is greater than the first threshold. In such a configuration, the inputted at least the portion of the probe region may include the second set of subregions of the first plurality of subregions. The blocks 914, 916, 918 are provided as an algorithm to block 904. However, the blocks 914, 916, 918 may be performed with any Siamese tracker. Occlusion prediction is further discussed with respect to FIG. 10.

FIG. 10 is a diagram 1000 that illustrates an example of occlusion prediction for visual object tracking using a Siamese tracker. In this example, two input images 1002 and 1004 to the Siamese tracker may be split into rigid cells (e.g., cells 1011-1019 for the input image 1002, and cells 1021-1029 for the input image 1004). Diagrams 1006 and 1008 show an example of splitting the representations of the two images. Instead of computing the similarity between the entire images 1002 and 1004, the Siamese tracker may compute the similarity for each pair of corresponding cells (e.g., 1011 vs. 1021, 1012 vs. 1022, 1013 vs. 1023, etc.). This way, the spatial evidence for a candidate region may be estimated based on the similarities for each pair of corresponding cells. In one configuration, the similarities between two input images 1002 and 1004 may be a combination of the similarities of cell pairs that are not occluded.

If there is occlusion, there may be a sharp difference between the contribution of the non-occluded part and the contribution of the occluded part to the final similarity score. In one configuration, if the similarity is concentrated on part of the candidate (e.g., the cells 1021-1026), then the rest part (e.g., the cells 1027-1029) may be occluded.

If occlusion happens at frame t (no occlusion at t−1), there may be a sudden drop in similarity contribution between frames t−1 and t for the occluded part. In one configuration, if there is sudden drop in similarity for a certain part from one frame to the next frame while similarity for the other part remains approximately the same, the part that has sudden drop in similarity may be occluded at frame t.

FIG. 11 is a flowchart 1100 of a method of visual object tracking. The method may be performed by a computing device (e.g., the apparatus 1202/1202′) that is configured as a Siamese tracker. At 1102, the device may divide each of a first image and a second image into the same number of regions. Each region of the first image may have the same shape and size as a corresponding region of the second image. In one configuration, the first image may be sampled from the first/starting frame of a video and the second image may be sampled from the current frame under processing. The current frame may be subsequent to the first frame.

At 1104, the device may compare each region of the first image with the corresponding region of the second image to obtain a similarity score for the region. In one configuration, the comparing may be performed by a Siamese neural network of the Siamese tracker.

At 1106, the device may determine, for each region of the second image, whether the region is occluded based on the similarity score for the region and similarity scores for other regions. In one configuration, a set of regions of the second image may be determined to be occluded when each similarity score for the set of regions satisfies a first threshold T₁ and each similarity score for other regions of the second image satisfies a second threshold T₂. In one configuration, a similarity score for a region of the second image satisfying the first threshold T₁ may indicate a mismatch between the region of the first image and a corresponding region of the second image, and a similarity score for a region of the second image satisfying the second threshold T₂ may indicate a match between the region of the first image and a corresponding region of the second image.

In one configuration, a set of regions of the second image in a current frame may be determined to be occluded when each similarity score (determined based on a comparison of corresponding regions in the second image of the current frame and the first image of the initial/starting frame) for the set of regions is less than a first threshold T₁, while each similarity score (determined based on a comparison of corresponding regions in the second image of the current frame and the first image of the initial/starting frame) for other regions is greater than a second threshold T₂, in which the second threshold T₂ is greater than the first threshold T₁ (T₂>T₁). Such other regions may be determined to be non-occluded (or un-occluded).

For example, referring to FIG. 10, the similarity scores S_{1027,1017}, S_{1028,1018}, and S_{1029,1019} for comparison of regions corresponding to cells 1017 and 1027, cells 1018 and 1028, and cells 1019 and 1029, respectively, may each be determined to be less than the first threshold T₁. Further, the similarity scores S_{1021,1011}, S_{1022,1012}, S_{1023,1013}, S_{1024,1014}, S_{1025,1015}, and S_{1026,1016} for comparison of the regions corresponding to cells 1011 and 1021, cells 1012 and 1022, cells 1013 and 1023, cells 1014 and 1024, cells 1015 and 1025, and cells 1016 and 1026, respectively, may each be determined to be greater than the second threshold T₂, where T₂>T₁. In such case, each of the cells 1027, 1028, 1029 may be determined to mismatch to cells 1017, 1018, 1019, respectively, and therefore to be occluded, and each of the cells 1021, 1022, 1023, 1024, 1025, 1026 may be determined to be sufficiently matched to cells 1011, 1012, 1013, 1014, 1015, 1016, respectively, to therefore be considered non-occluded/un-occluded.

At 1108, the device may determine the similarity between the first image and the second image based on similarity scores for regions that are non-occluded/un-occluded. Therefore, the occluded regions may not affect the outcome in determining the similarity between two images.

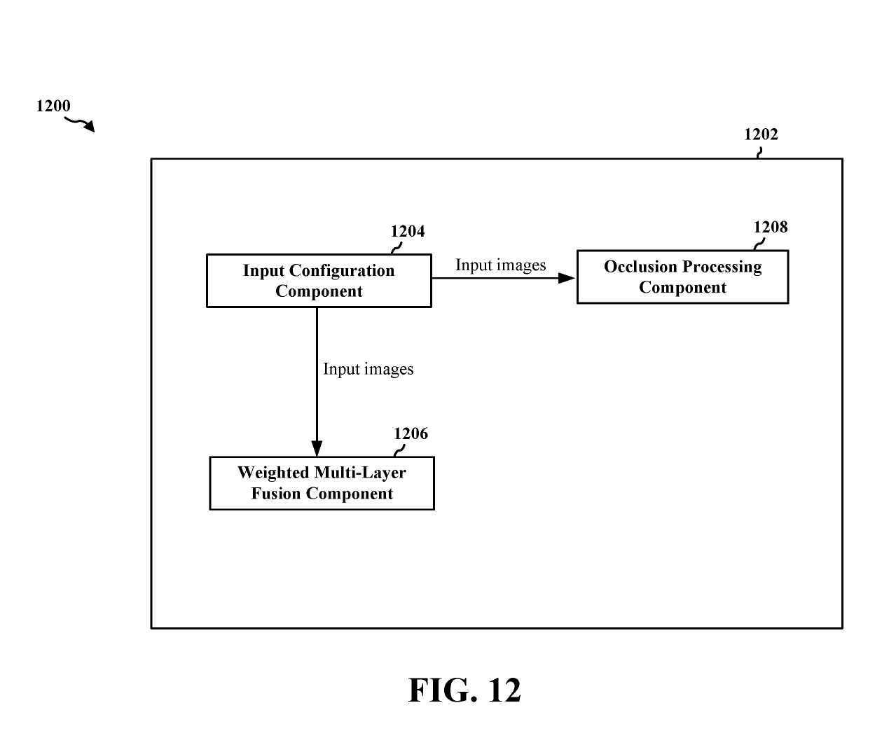

FIG. 12 is a conceptual data flow diagram 1200 illustrating the data flow between different means/components in an exemplary apparatus 1202. The apparatus 1202 may be a computing device.

The apparatus 1202 may include an input configuration component 1204 that configures input images by, e.g., adjusting spatial resolution of input images, adjusting probe region size, or adjusting the scale of image sampling. In one configuration, the input configuration component 1204 may generate input images for the Siamese neural network. In one configuration, the input configuration component 1204 may perform operations described above with reference to FIG. 7.

The apparatus 1202 may include a weighted multi-layer fusion component 1206 that combines comparison results for multiple layers based on weights dynamically generated for different layers. In one configuration, the weighted multi-layer fusion component 1206 may receive input images from the input configuration component 1204. In one configuration, the weighted multi-layer fusion component 1206 may perform operations described above with reference to FIG. 9.

The apparatus 1202 may include a occlusion processing component 1208 that estimates occlusions to improve the performance of the Siamese tracker. In one configuration, the occlusion processing component 1208 may perform operations described above with reference to FIG. 11.

The apparatus may include additional components that perform each of the blocks of the algorithm in the aforementioned flowcharts of FIGS. 7, 9, 11. As such, each block in the aforementioned flowcharts of FIGS. 7, 9, 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

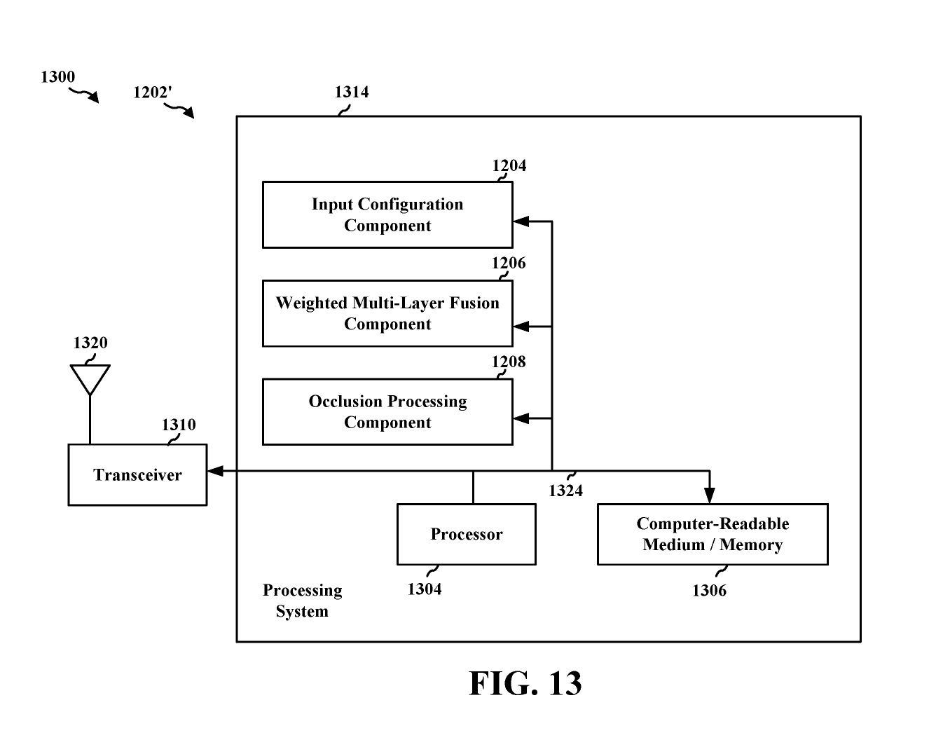

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware components, represented by the processor 1304, the components 1204, 1206, 1208, and the computer-readable medium/memory 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 may be coupled to one or more antennas 1320. The transceiver 1310 provides a means for communicating with various other apparatus over a transmission medium. The transceiver 1310 receives a signal from the one or more antennas 1320, extracts information from the received signal, and provides the extracted information to the processing system 1314. In addition, the transceiver 1310 receives information from the processing system 1314, and based on the received information, generates a signal to be applied to the one or more antennas 1320. The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system 1314 further includes at least one of the components 1204, 1206, 1208. The components may be software components running in the processor 1304, resident/stored in the computer readable medium/memory 1306, one or more hardware components coupled to the processor 1304, or some combination thereof.

In one configuration, the apparatus 1202/1202′ may include means for receiving a position of an object in a first frame of a video. In one configuration, the apparatus 1202/1202′ may include means for determining a current position of the object in subsequent frames of the video using a Siamese neural network. The means for determining the current position of the object may be configured to perform one or more of: adjusting the spatial resolution of a first image from the first frame of the video and a second image sampled from a current frame under processing; adjusting the size of a probe region on the current frame under processing based on a metric of movement of the object from one frame to another; or adjusting the scale of a plurality of images sampled from the current frame under processing. In one configuration, to adjust the spatial resolution of the first image and the second image, the means for determining the current position of the object may be configured to up-sample or down-sample a first image region on the first frame and a second image region on the current frame.

In one configuration, the apparatus 1202/1202′ may include means for feeding outputs from a plurality of layers of a first subnetwork of the Siamese neural network and a second subnetwork of the Siamese neural network to a comparison layer. In one configuration, the apparatus 1202/1202′ may include means for comparing, for each layer of the plurality of layers, a first input from the layer in the first subnetwork with a second input from the layer in the second subnetwork to obtain a comparison result for the layer. In one configuration, the apparatus 1202/1202′ may include means for combining comparison results for the plurality of layers based on weights dynamically generated for the plurality of layers to obtain a final comparison result.

In one configuration, the apparatus 1202/1202′ may include means for inputting, of an initial frame, a query region including a target into the layers of the first subnetwork of the Siamese neural network. In addition, the apparatus may include means for inputting, of a current frame, at least a portion of a probe region into the layers of the second subnetwork of the Siamese neural network. Further, the apparatus may include means for determining based on the final comparison result whether the at least the portion of the probe region includes the target.

In one configuration, the apparatus 1202/1202′ may include means for comparing a first plurality of subregions of a subregion of the probe region of the current frame with a second plurality of subregions of the query region of the initial frame. The apparatus may further include means for determining a similarity score for each of the first plurality of subregions based on the comparison. The apparatus may further include means for determine that a first set of subregions of the first plurality of subregions is occluded when the similarity score for each subregion of the first set of subregions is less than a first threshold and when the similarity score for each subregion of a second set of subregions is greater than a second threshold, where the second threshold is greater than the first threshold. In such a configuration, the inputted at least the portion of the probe region includes the second set of subregions of the first plurality of subregions.

In one configuration, the apparatus 1202/1202′ may include means for dividing each of a first image and a second image into a same number of regions, each region of the first image having a same shape and size as a corresponding region of the second image. In one configuration, the apparatus 1202/1202′ may include means for comparing each region of the first image with the corresponding region of the second image to obtain a similarity score for the region. In one configuration, the means for comparing may include a Siamese neural network. In one configuration, the apparatus 1202/1202′ may include means for determining, for each region of the second image, whether the region is occluded based on the similarity score for the region and similarity scores for other regions. In one configuration, the apparatus 1202/1202′ may include means for determining a similarity between the first image and the second image based on similarity scores for regions that are un-occluded.

The aforementioned means may be one or more of the aforementioned components of the apparatus 1202 and/or the processing system 1314 of the apparatus 1202′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of visual object tracking, comprising:
receiving a position of an object in a first frame of a video; and
determining a current position of the object in subsequent frames of the video using a Siamese neural network, wherein the determining the current position of the object comprises one or more of:
adjusting a spatial resolution of a first image from the first frame of the video and a second image sampled from a current frame under processing, the first image and the second image being inputs to the Siamese neural network;
adjusting a size of a probe region on the current frame under processing based on a metric of movement of the object from one frame to another; or
adjusting a scale of a plurality of images sampled from the current frame under processing, the plurality of images being inputs to the Siamese neural network.

2. The method of claim 1, wherein the spatial resolution of the first image and the second image is adjusted based on a size of the object and an amount of spatial reduction caused by the Siamese neural network.

3. The method of claim 1, wherein the adjusting the spatial resolution of the first image and the second image comprises up-sampling or down-sampling a first image region on the first frame and a second image region on the current frame.

4. The method of claim 1, wherein the scale of the plurality of images comprises sizes and number of the plurality of images.

5. The method of claim 1, wherein the scale of the plurality of images is adjusted based on an estimated scale in a frame immediately before the current frame.

6. A method of visual object tracking using a Siamese neural network, comprising:
feeding outputs from a plurality of layers of a first subnetwork of the Siamese neural network and a second subnetwork of the Siamese neural network to a comparison layer;
comparing, at the comparison layer for each layer of the plurality of layers, a first input from the layer in the first subnetwork with a second input from the layer in the second subnetwork to obtain a comparison result for the layer; and
combining comparison results for the plurality of layers based on weights dynamically generated for the plurality of layers to obtain a final comparison result.

7. The method of claim 6, wherein the first subnetwork and the second subnetwork are identical.

8. The method of claim 6, wherein the plurality of layers are penultimate layers of the first subnetwork and the second subnetwork.

9. The method of claim 6, wherein the weights are generated by a neural network that is trained concurrently with the Siamese neural network.

10. The method of claim 6, wherein the final comparison result is a weighted sum of the comparison results for the plurality of layers.

11. The method of claim 6, wherein the final comparison result is a weighted average of the comparison results for the plurality of layers.

12. The method of claim 6, further comprising:
inputting, of an initial frame, a query region including a target into the layers of the first subnetwork of the Siamese neural network;
inputting, of a current frame, at least a portion of a probe region into the layers of the second subnetwork of the Siamese neural network; and
determining based on the final comparison result whether the at least the portion of the probe region includes the target.

13. The method of claim 12, further comprising:
comparing a first plurality of subregions of a subregion of the probe region of the current frame with a second plurality of subregions of the query region of the initial frame;
determining a similarity score for each of the first plurality of subregions based on the comparison;
determining that a first set of subregions of the first plurality of subregions is occluded when the similarity score for each subregion of the first set of subregions is less than a first threshold and when the similarity score for each subregion of a second set of subregions is greater than a second threshold, the second threshold being greater than the first threshold,
wherein the inputted at least the portion of the probe region comprises the second set of subregions of the first plurality of subregions.

14. An apparatus for visual object tracking, comprising:
a memory; and
at least one processor coupled to the memory and configured to:
receive a position of an object in a first frame of a video; and
determine a current position of the object in subsequent frames of the video using a Siamese neural network,
wherein, to determine the current position of the object, the at least one processor is configured to perform one or more of:
adjusting a spatial resolution of a first image from the first frame of the video and a second image sampled from a current frame under processing, the first image and the second image being inputs to the Siamese neural network;
adjusting a size of a probe region on the current frame under processing based on a metric of movement of the object from one frame to another; or
adjusting a scale of a plurality of images sampled from the current frame under processing, the plurality of images being inputs to the Siamese neural network.

15. The apparatus of claim 14, wherein the spatial resolution of the first image and the second image is adjusted based on a size of the object and an amount of spatial reduction caused by the Siamese neural network.

16. The apparatus of claim 14, wherein, to adjust the spatial resolution of the first image and the second image, the at least one processor is configured to up-sample or down-sample a first image region on the first frame and a second image region on the current frame.

17. The apparatus of claim 14, wherein the scale of the plurality of images comprises sizes and number of the plurality of images.

18. The apparatus of claim 14, wherein the scale of the plurality of images is adjusted based on an estimated scale in a frame immediately before the current frame.

19. An apparatus for visual object tracking using a Siamese neural network, comprising:
a memory; and
at least one processor coupled to the memory and configured to:
feed outputs from a plurality of layers of a first subnetwork of the Siamese neural network and a second subnetwork of the Siamese neural network to a comparison layer;
compare, at the comparison layer for each layer of the plurality of layers, a first input from the layer in the first subnetwork with a second input from the layer in the second subnetwork to obtain a comparison result for the layer; and
combine comparison results for the plurality of layers based on weights dynamically generated for the plurality of layers to obtain a final comparison result.

20. The apparatus of claim 19, wherein the first subnetwork and the second subnetwork are identical.

21. The apparatus of claim 19, wherein the plurality of layers are penultimate layers of the first subnetwork and the second subnetwork.

22. The apparatus of claim 19, wherein the weights are generated by a neural network that is trained concurrently with the Siamese neural network.

23. The apparatus of claim 19, wherein the final comparison result is a weighted sum of the comparison results for the plurality of layers.

24. The apparatus of claim 19, wherein the final comparison result is a weighted average of the comparison results for the plurality of layers.

25. The apparatus of claim 19, wherein the at least one processor is further configured to:
input, of an initial frame, a query region including a target into the layers of the first subnetwork of the Siamese neural network;
input, of a current frame, at least a portion of a probe region into the layers of the second subnetwork of the Siamese neural network; and
determine based on the final comparison result whether the at least the portion of the probe region includes the target.

26. The apparatus of claim 25, wherein the at least one processor is further configured to:
compare a first plurality of subregions of a subregion of the probe region of the current frame with a second plurality of subregions of the query region of the initial frame;
determine a similarity score for each of the first plurality of subregions based on the comparison;
determine that a first set of subregions of the first plurality of subregions is occluded when the similarity score for each subregion of the first set of subregions is less than a first threshold and when the similarity score for each subregion of a second set of subregions is greater than a second threshold, the second threshold being greater than the first threshold,
wherein the inputted at least the portion of the probe region comprises the second set of subregions of the first plurality of subregions.
